(19) United States
(12) Patent Application Publication
(10) Pub. No.: US 2025/0087109 A1
(43) Pub. Date: Mar. 13, 2025

(54) MOBILE CONFINED SPACE TRAINING SYSTEM AND ASSOCIATED DEVICES AND METHODS

(71) Applicant: Missouri Valley JATC, Indianola, IA (US)

(72) Inventors: Robert M. Foxen, West Des Moines, IA (US); Paul Hughes, Indianola, IA (US)

(21) Appl. No.: 18/882,474

(22) Filed: Sep. 11, 2024

Related U.S. Application Data
(60) Provisional application No. 63/537,726, filed on Sep. 11, 2023.

(51) Int. Cl. G09B 19/00; B60P 3/00; B60S 9/02

(52) U.S. Cl. CPC G09B 19/00; B60P 3/00; B60S 9/02

(57) ABSTRACT

The disclosed system, and related devices and methods, relate to a structure capable of enabling confined-space-entry training while being portable and allowing for observation by large numbers of trainees. It accomplishes this by way of a telescoping series of nested structures. This series of structures can be erected for use and lowered and stowed for transportation.

### CROSS REFERENCE TO RELATED APPLICATION(S)

This application claims priority to U.S. Provisional Application No. 63/537,726 filed Sep. 11, 2023, entitled “MOBILE CONFINED SPACE TRAINING SYSTEM AND ASSOCIATED DEVICES AND METHODS”, which is hereby incorporated by reference in its entirety under 35 U.S.C. § 119 (e).

### BACKGROUND

The disclosure relates to confined-space-entry (“CSE”) training, the methods of conducting that training, and the equipment employed in such training.

There is a need in the art for a system of CSE training that allows for a large number of trainees to observe while also allowing for a training system that can relocate to areas of high demand.

Traditionally, CSE training was done in underground vaults with small openings at the top. Because the vaults were underground and immobile, students had to travel to the training sites, often having to travel significant distances. Additionally, because the confined spaces were underground, very few students could observe examples and instructions at any one time. This led to the limitation of either class size, the lengthening of training times, or the degradation of training quality.

More recently, towers have been used to simulate confined space entries during CSE training. Rather than descending into an actual confined space, students and instructors descend from the top of a tower to the ground. This allows for instruction on the fundamentals of the decent but allows for the portions of the training traditionally done within the confined space, such as securing and extracting the rescue target, to be observed by bystanders because the tasks are done in the open and on ground level.

However, these towers are still generally large structures that are difficult to move. This typically means the students still need to travel to training sites, adding cost and logistical complexity to training. The herein contained disclosure solves this long felt, yet so far, unsolved problem in the field of CSE training.

### BRIEF SUMMARY

Described herein are various implementations relating to a confined-space-entry (“CSE”) system to provide mobile confined-space-entry training, and the associated devices and methods. This system improves upon previous training systems in that it provides greater visibility for observers during the training and provides for an increased ease of transportation of the training equipment. Previous CSE training methods employed either underground vaults or large, fixed towers. The vault training required trainees to enter the vault to perform the training tasks, making it difficult for other trainees to observe and learn from the training of others. The vaults are also immobile, requiring trainees to travel to the training site. Fixed training towers resolve the visibility issue but remain immobile.

The claimed system employs a series of telescoping structures that nest inside one another. Their telescoping nature allows for the system to employ a tall tower but remain mobile when the structures are stowed.

Example 1 relates to a system for providing safety training comprising: (a) a trailer; and (b) one or more towers storable within the trailer, each comprising one or more tower segments.

Example 2 relates to Examples 1 and 3-12, further comprising: (a) one or more winches attached to the trailer; (b) one or more cables connecting the one or more towers to the one or more winches; and (c) one or more pulleys attached to the trailer, wherein the one or more pulleys are configured to direct the placement of the cable.

Example 3 relates to Examples 1-2 and 4-12, wherein the one or more towers each comprise one or more tower segments.

Example 4 relates to Examples 1-3 and 5-12, wherein the one or more tower segments are nested within one another and wherein the one or more tower segments can extend from a nested position.

Example 5 relates to Examples 1-4 and 6-12, further comprising one or more temporary jigs removably attached to the one or more towers.

Example 6 relates to Examples 1-5 and 7-12, wherein the temporary jigs interact with the cable such that the cable, when attached to the one or more towers and reeled in by the one or more winches, causes the transition of the one or more tower segments from the nested position to an extended position.

Example 7 relates to Examples 1-6 and 8-12, further comprising one or more outriggers removably attached to the one or more towers.

Example 8 relates to Examples 1-7 and 9-12, further comprising one or more guy wires removably attached to the one or more towers.

Example 9 relates to Examples 1-8 and 10-12, wherein the guy wires are attached between the one or more towers and the trailer.

Example 10 relates to Examples 1-9 and 11-12, wherein the guy wires are attached between the one or more towers and the ground.

Example 11 relates to Examples 1-10 and 12, further comprising slide pads attached to the one or more tower segments.

Example 12 relates to Examples 1-11, wherein the slide pads of different one or more tower segments allow slidable communication between said one or more tower segments.

Example 13 relates to a method for assembling a safety training system comprising: securing one or more towers to a trailer, wherein the one or more towers each comprise one or more tower segments; extending one or more of the towers; and bracing one or more of the towers.

Example 14 relates to Examples 13 and 15-18, wherein the bracing of the one or more towers is done via guy wires.

Example 15 relates to Examples 13-14 and 16-18, wherein the bracing of the one or more towers is done via attaching outriggers.

Example 16 relates to Examples 13-15 and 17-18, wherein the securing of the one or more towers to a trailer is done by fastening the lowest tower segment to the trailer.

Example 17 relates to Examples 13-16 and 18, wherein the extending of the one or more towers is accomplished by reeling the one or more cables in using the one or more winches.

Example 18 relates to Examples 13-17, wherein one or more temporary jigs are used to direct the one or more cables when extending the one or more towers.

Example 19 relates to a system for providing safety training comprising: (a) a trailer; (b) one or more towers storable within the trailer, each comprising one or more tower segments; (c) one or more winches attached to the trailer; (d) one or more cables connecting the one or more towers to the one or more winches; and (e) one or more pulleys attached to the trailer, wherein the one or more pulleys are configured to guide the placement of the cable.

Example 20 relates to Example 19, further comprising: (a) outriggers removably attached to the one or more towers; (b) one or more guy wires removably attached to the one or more towers; and (c) one or more doors on the trailer.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive

### BRIEF DESCRIPTION OF THE DRAWINGS

FIG. 1 shows the system in profile with tower erected.

FIG. 2 shows the system in profile with tower erected with additional structural detail.

FIG. 3 shows the system viewed from the rear, which is the training side of the system.

FIG. 4 shows the system viewed from the top, with outriggers and internal braces in place.

FIG. 5 shows the system viewed from the front.

FIG. 6 shows the system viewed from the top, with the manhole shown.

FIG. 7A shows the trailer in an isometric view with a door open.

FIG. 7B shows the trailer in an isometric view with the doors closed.

FIG. 7C shows the trailer from the top.

FIG. 8A shows the trailer from the left side.

FIG. 8B shows the trailer from the right side.

FIG. 9A shows the trailer in an isometric view.

FIG. 9B shows a close image of the manhole, from an isometric view.

FIG. 10 shows the tower segments in detail.

### DETAILED DESCRIPTION

Described herein is a confined-space-entry (“CSE”) system 1 configured to provide mobile confined-space-entry training, and the associated devices and methods of use. In various implementations, the system 1 improves upon previous training systems in that it provides greater visibility for observers during the training and provides for an increased ease of transportation of the training equipment via, for example a trailer 10.

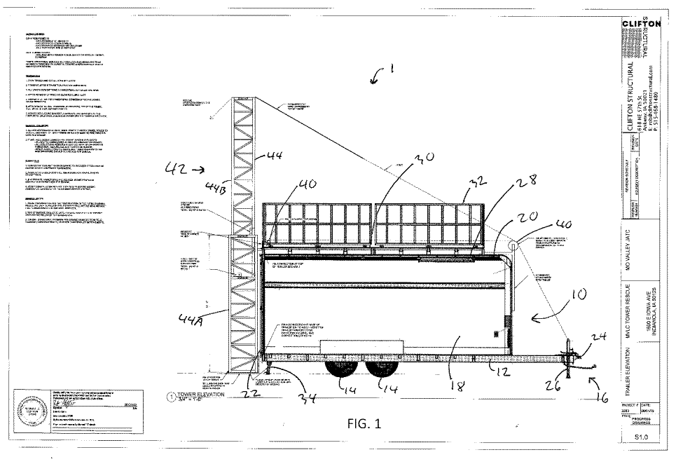

Turning to the drawings in greater detail, the implementation of the system 1 shown in FIG. 1 comprises a trailer 10, which comprises a base 12, wheels 14, a hitch 16, walls 18, a roof 20, and one or more doors 22. In these implementations, the base 12 can be a flat, rigid structure, typically longer from front to back than it is side to side. The base 12 can be attached to the hitch 16, with the hitch 16 being fixed at the front of the base 12. The wheels 14 are attached to the base 12 such that the weight of the trailer 10 is mostly supported by the wheels 14, with some remaining amount of weight being supported by the hitch 16. The hitch 16 comprises a trailer coupler 24, which is capable of attaching to any number of standard trailer balls or other attachment mechanisms commonly known in the art. The hitch 16 further comprises a stand 26 which can support the portion of the weight of the trailer 10 not supported by the wheels 14 and which can pivot such that it will not support any weight when a trailer ball, attached to a vehicle, is coupled with the trailer coupler 24. The walls 18 are attached to the base 12, typically at the sides of the base 12, and extend upwards. The portion of the walls 18 extending away from the base 12 is the top of the walls 18. The roof 20 is attached to the top of the walls, and typically spans the entirety of the area of the base 12.

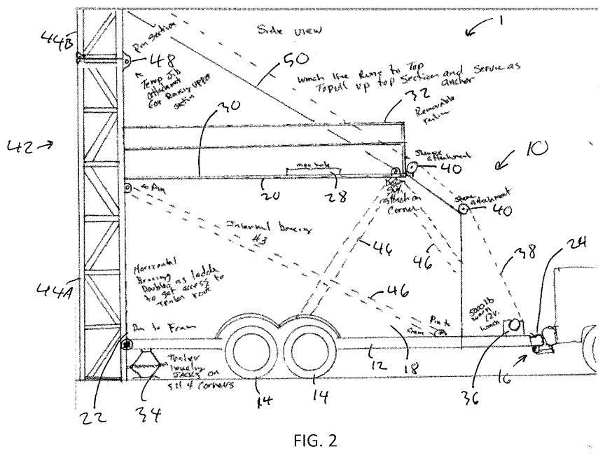

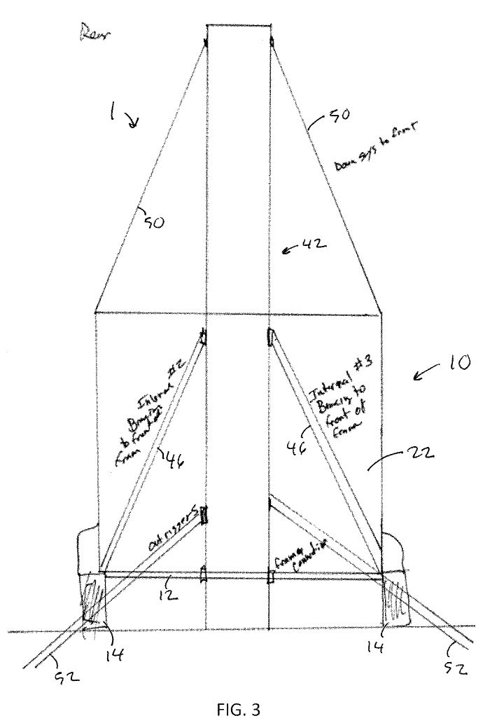

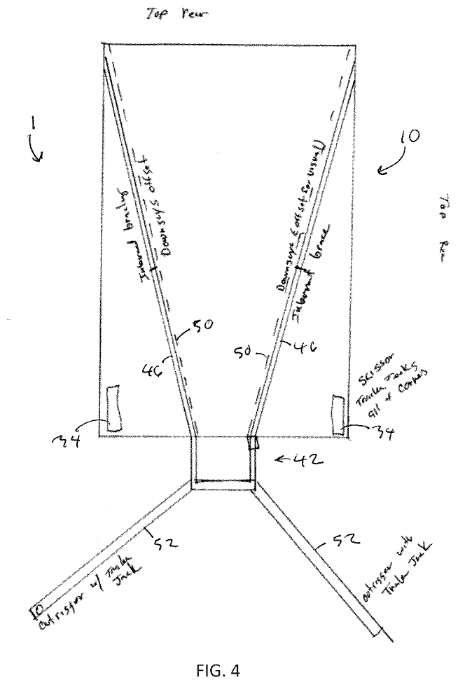

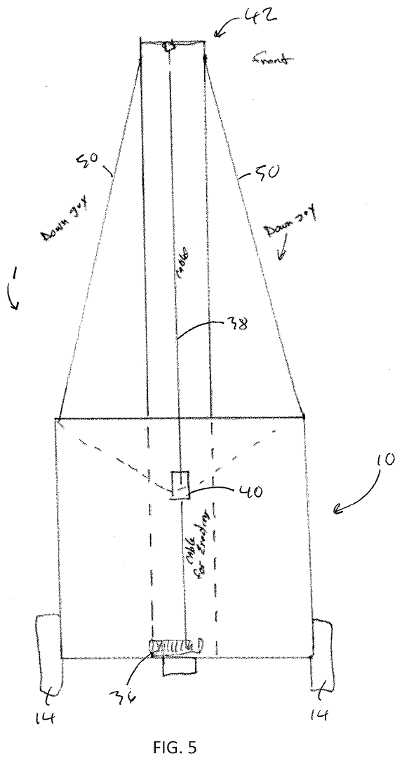

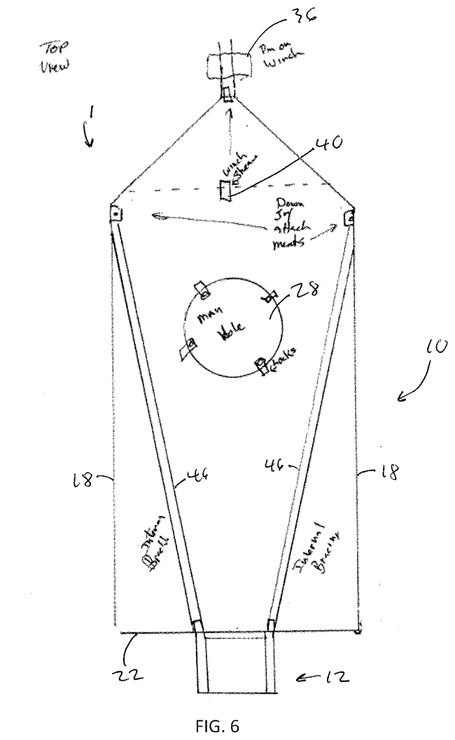

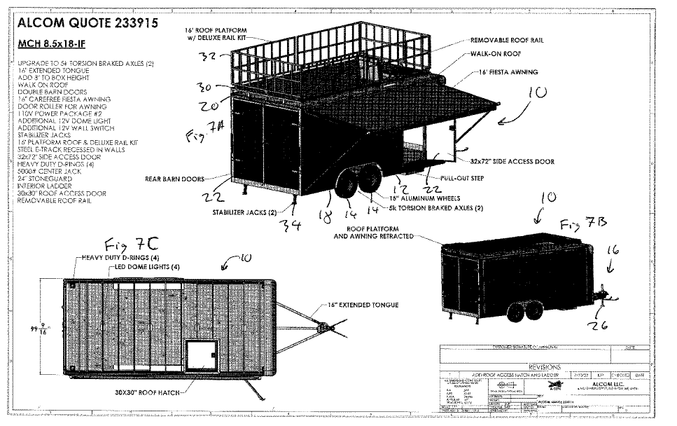

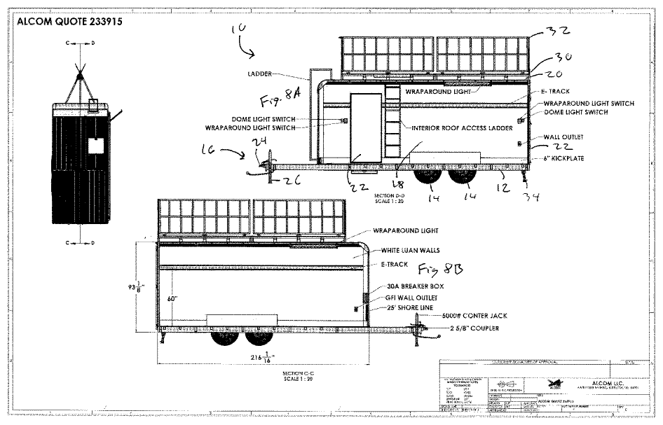

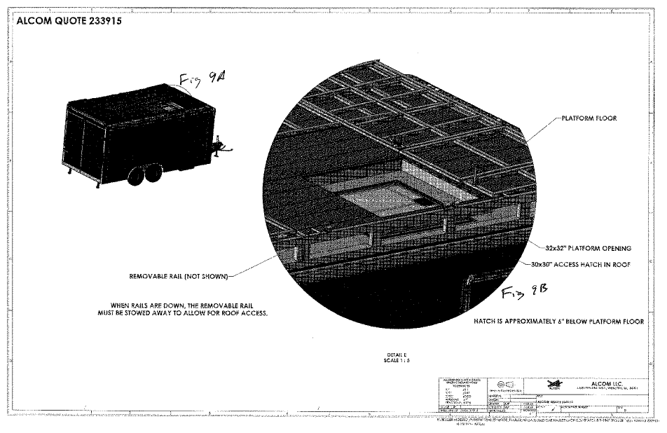

Continuing with the implementation of the system 1 shown in FIGS. 1-2, the roof 20 can also feature a manhole 28, allowing for access to the interior of the trailer 10 through the roof 20. The roof 20 can also feature a walking platform 30, attached above the roof 20. The walking platform 30 can feature a handrail 32, affixed to the perimeter or portion thereof of the walking platform 30. A door 22 can be fitted onto the wall 18 affixed to the rear of the base 12, which is the rear of the trailer 10. This door 22 can also replace the entire wall 18 at the rear of the trailer 10. Other doors 22 can be placed in other walls 18 and are typically smaller in size than the rear door 22. As shown in the implementations of FIGS. 1-2 and then further in FIGS. 3-4, there are one or more, typically two or four, leveling feet 34 attached to the bottom side of the base 12. The leveling feet 34 are capable of extending such that they remove all weight from the wheels 14 and hitch 16 while also allowing for leveling of the base 12.

As shown for example in FIG. 2, a winch 36 is affixed to the base, typically between the wall 18 nearest to the front of the base 12 and the hitch 16. It is also typical that the winch 36 is mounted about equidistant between the two sides of the base 12. The winch 36 can use a rotary motor to reel in or extend a cable 38, which is affixed at one end to the winch 36. The portion of the cable 38 not reeled up by the winch 36 can ride along pulleys 40. These pulleys 40 can be placed anywhere that allows for the cable 38 to avoid contact with other objects. At least one pully 40 is typically mounted near the intersection of the wall 18 nearest to the front of the base 12 and the roof 20.

Returning to the implementations of FIGS. 1-2, the system 1 can also have a tower 42. The tower 42 according to certain implementations can consist of multiple tower segments 44. The tower segments 44 can be rectangular and can be made of tubular portions configured into a lattice structure. It is appreciated that in certain implementations, the tower segments 44 are configured such that they can nest inside each other so that they can be positioned to only occupy the space of the outermost tower segment 44A. In certain implementations, the tower segments 44 are in slidable communication with each other. In further implementation, the tower segments 44 achieve slidable communication through slide pads positioned on the tower segments 44. In another implementation, the slide pads are constructed of a synthetic, low friction material. Further configurations for economizing space and providing for the retraction and expansion of the tower 44 are of course possible.

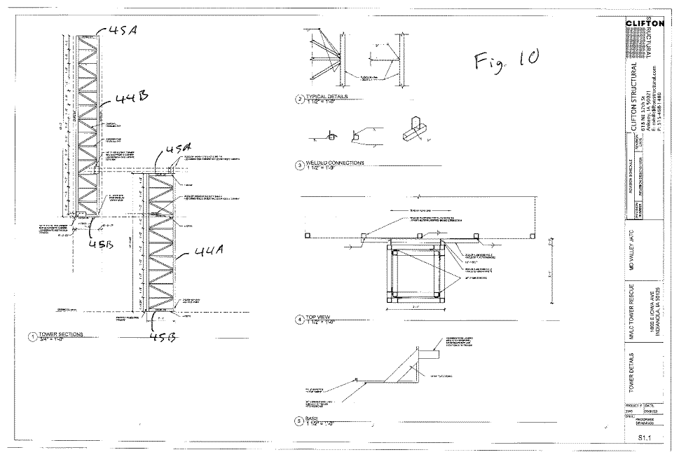

In the implementations of FIGS. 1-2, the tower segments 44 can also extend such that the inner tower segments 44B protrude from the outer tower segments 44A. Enough of each inner tower segment 44B remains nested in the outer tower segment 44A to allow the segments 44A, 44B to be secured together. As shown in FIG. 10, each tower segment 44A, 44B has a first end 45A and a second end 45B, with the first end 45A and second end 45B being on opposite ends of their longest dimension. In these implementations, all tower segments 44A, 44B first end 45A are oriented in the same general direction, and their second ends 45B correspondingly oriented in the opposite direction. The outermost tower segment 44A can be secured to the trailer 10, typically at the rear. When secured to the trailer 10, the outermost tower segment 44A has its second end 45B placed on the ground and its first end 45A pointing upwards. The other tower segments 44 are typically nested inside the outermost tower segment 44A while securing it to the trailer 10. One or more internal braces 46 are used to stabilize the outermost tower segment 44A while secured to the trailer 10. The internal braces 46 are typically metal, tubular beams that secure at one end to the base 12 and at the other end to the outermost tower segment 44A. While the implementations shown in FIGS. 1-2 contain tower segments 44 shown to be square, trussed structures, many other structures may be used, such as wooden poles, metal poles, polymer poles, and other structures that those in the art would consider equivalent. Additionally, the inner tower segment 44B and outermost tower segment 44A may adjust their position relative to each other through means other than the nested, telescoping configured shown in FIGS. 1-2. For instance, the inner tower segment 44B and outermost tower segment 44A may adjust their position relative to one another by hinging, sliding, or the like. In various implementations, the tower 42 may be made of a single tower segment 44, rather than more than one.

As shown in FIG. 2, in certain implementations, each tower segment 44 can be fitted with a temporary jig 48. The temporary jig 48 is configured such that the cable 38 can be guided through the temporary jig 48 in a manner that directs any force applied by the winch 36 to the cable 38, when reeled in, upwards, at the end of the cable 38 not affixed to the winch 36. The upward-directed force allows for the end of the cable 38 not affixed to the winch 36 to be secured to one or more tower segments 44, not including the outermost tower segment 44A, and the secured tower segment or segments 44 can be lifted above tower segments 44 outer than itself or themselves. Once each tower segment 44 is lifted so that it is protruding from the tower segment 44 one outer than itself, the two tower segments 44 can be secured in the extended and lifted configuration. This can be repeated for as many pairs of tower segments 44 as are present. Once each tower segment 44 pair is secured in the lifted configuration, the temporary jig 48 can be removed and moved to another tower segment 44 pair, if necessary.

As shown in FIG. 3, in use according to certain implementations, once the tower 42—comprising the tower segments 44—is extended to its desired height and secured there, guy wires 50 can be affixed to the top of the tower 42 and to the roof 20, or another secure location, in such a way as to provide tension along the guy wires 50 such that they provide stability to the tower 42. Outriggers 52 can be affixed to the outermost tower segment 44A or another tower segment 44 to provide additional stability to the tower 42. The outriggers 52 are typically metal beams secured on one end to the corners of the outermost tower segment 44A not secured to the trailer 10, with their other ends secured against or into the earth around the tower 42. The outriggers 52 can be detached from the outermost tower segment 44A when not in use.

In use according to certain implementations, once the tower 42 is secured in a manner above or a manner similar, the tower 42 can provide an elevated support for various training methods known in the art. When the tower 42 is to be transported, the guy wires 50 and outriggers 52 can be removed. Then the temporary jig 48 can be attached to one of the tower segment 44 pairs. Using the cable 38 and winch 36, the inner tower segments 44B can be lowered into the outer. This can be repeated, if necessary, until all tower segments 44 are nested in each other. Once all tower segments 44 are nested, the outermost tower segment 44A can be unsecured from the trailer 10. The nested tower segments 44 can then be stored inside of the trailer 10 by way of the door 22 on the rear of the trailer 10.

Although the disclosure has been described with reference to certain preferred embodiments, persons skilled in the art will recognize that changes may be made in form and detail without departing from the spirit and scope of the disclosed apparatus, systems and methods.

What is claimed is:

1. A system for providing safety training comprising:
(a) a trailer; and
(b) one or more towers storable within the trailer, each comprising one or more tower segments.

2. The system of claim 1 further comprising:
(a) one or more winches attached to the trailer;
(b) one or more cables connecting the one or more towers to the one or more winches; and
(c) one or more pulleys attached to the trailer,
wherein the one or more pulleys are configured to direct the placement of the cable.

3. The system of claim 2 wherein the one or more towers each comprise one or more tower segments.

4. The system of claim 3 wherein the one or more tower segments are nested within one another and wherein the one or more tower segments can extend from a nested position.

5. The system of claim 4 further comprising one or more temporary jigs removably attached to the one or more towers.

6. The system of claim 5 wherein the temporary jigs interact with the cable such that the cable, when attached to the one or more towers and reeled in by the one or more winches, causes the transition of the one or more tower segments from the nested position to an extended position.

7. The system of claim 2 further comprising one or more outriggers removably attached to the one or more towers.

8. The system of claim 2 further comprising one or more guy wires removably attached to the one or more towers.

9. The system of claim 8 wherein the guy wires are attached between the one or more towers and the trailer.

10. The system of claim 9 wherein the guy wires are attached between the one or more towers and the ground.

11. The system of claim 4 further comprising slide pads attached to the one or more tower segments.

12. The system of claim 11 wherein the slide pads of different one or more tower segments allow slidable communication between said one or more tower segments.

13. A method for assembling a safety training system comprising:
securing one or more towers to a trailer, wherein the one or more towers each comprise one or more tower segments;
extending one or more of the towers; and
bracing one or more of the towers.

14. The method of claim 13 wherein the bracing of the one or more towers is done via guy wires.

15. The method of claim 13 wherein the bracing of the one or more towers is done via attaching outriggers.

16. The method of claim 13 wherein the securing of the one or more towers to a trailer is done by fastening the lowest tower segment to the trailer.

17. The method of claim 13 wherein the extending of the one or more towers is accomplished by reeling the one or more cables in using the one or more winches.

18. The method of claim 17 wherein one or more temporary jigs are used to direct the one or more cables when extending the one or more towers.

19. A system for providing safety training comprising:
(a) a trailer;
(b) one or more towers storable within the trailer, each comprising one or more tower segments;
(c) one or more winches attached to the trailer;
(d) one or more cables connecting the one or more towers to the one or more winches; and
(e) one or more pulleys attached to the trailer,
wherein the one or more pulleys are configured to guide the placement of the cable.

20. The system of claim 19 further comprising:
(a) outriggers removably attached to the one or more towers;
(b) one or more guy wires removably attached to the one or more towers; and
(c) one or more doors on the trailer.
